(19) United States
(12) Patent Application Publication
(10) Pub. No.: US 2026/0234978 A1
(43) Pub. Date: Aug. 13, 2026

(54) DOORSTOP

(71) Applicant: Uhooty LLC, Rogers, MN (US)

(72) Inventor: Ryan Wilson, Rogers, MN (US)

(21) Appl. No.: 19/537,054

(22) Filed: Feb. 11, 2026

Related U.S. Application Data
(60) Provisional application No. 63/757,064, filed on Feb. 11, 2025.

(51) Int. Cl. E05F 5/06; E05F 5/08; E06B 3/70; E06B 3/72; E06B 3/78; E06B 3/88; E06B 9/58

(52) U.S. Cl. CPC E05F 5/06; E05F 5/08; E06B 3/7001; E06B 3/72; E06B 3/78; E06B 3/88; E06B 9/581; C08L 2205/03; E06B 2003/7023

(57) ABSTRACT

A doorstop system that includes: a doorstop device having a base portion including a first surface and a second surface; a longitudinally-extending shaft portion including a base end, a head end, and an outside surface, the base end of the shaft portion fixedly joined to the base portion; a plurality of support portions joined to the first surface of the base portion and to the shaft portion; a head portion joined to the head end of the shaft portion. The shaft portion and the head portion together define a channel extending longitudinally through the shaft portion and the head portion, the channel forming a head-end opening at the head portion. The doorstop system also includes an adhesive plate having a base-contacting surface configured to adhesively contact the second surface of the base portion.

### CROSS-REFERENCE TO RELATED APPLICATIONS

This application claims the benefit of U.S. Provisional Application No. 63/757,064, filed Feb. 11, 2025, the entire disclosures of which are incorporated herein by reference.

### FIELD OF THE DISCLOSURE

The present disclosure is generally directed to devices for protecting doors and structures that may contact doors during a door swing. More specifically the present disclosure is directed to doorstop devices, systems and methods.

### BACKGROUND

Doorstops or doorstoppers that may be connected to a door, wall or wall molding to protect the wall and door from damage when the door impacts the wall or wall molding are well known in the industry. One well-known doorstop design includes a flexible metal coil spring attached to the wall or molding that has a rubber tip intended to butt up against a door surface. These traditional spring coil doorstops can present several drawbacks. Metal components may fatigue, bend, rust, or break over time, reducing the useful life of the device. Upon impact, metal coil springs can produce noise and vibration that may be undesirable in residential and commercial environments. Safety concerns may also arise with traditional designs, including pinching hazards from exposed coil springs, sharp edges on metal components, exposed screws, and choking hazards from removable rubber caps, particularly in homes with children. Installation of conventional doorstops typically requires tools and permanent fasteners such as screws, which can cause wall damage and may be unsuitable for rental properties where wall penetration is undesirable. Multi-part construction of traditional doorstops can increase manufacturing complexity and introduce additional failure points where components may separate or wear.

Some doorstop designs, in contrast to very flexible spring-design doorstoppers, may be formed of solid, rigid materials that unnecessarily limit movement of the doorstop when subjected to a bending force. Existing alternatives, such as rigid rubber bumpers or multi-piece elastomeric doorstops, may not replicate the functional behavior of a spring coil and can lack controlled flex, rebound, and durability. In some cases, these alternatives do not provide the combination of flexibility, energy absorption, and return-to-position behavior that users expect from a spring-type doorstop.

### SUMMARY

Embodiments of the present disclosure provide improved doorstop systems and devices manufacturable with simpler, cost effective manufacturing processes and materials.

One embodiment is a doorstop system that includes: a doorstop device having a base portion including a first surface and a second surface; a longitudinally-extending shaft portion including a base end, a head end, and an outside surface, the base end of the shaft portion fixedly joined to the base portion; a plurality of support portions joined to the first surface of the base portion and to the shaft portion; a head portion joined to the head end of the shaft portion. The shaft portion and the head portion together define a channel extending longitudinally through the shaft portion and the head portion, the channel forming a head-end opening at the head portion. The doorstop system also includes an adhesive plate having a base-contacting surface configured to adhesively contact the second surface of the base portion. In some cases, the channel is configured to receive a fastener.

Another embodiment is a doorstop device that includes: a base portion including a first surface and a second surface; a longitudinally-extending shaft portion including a base end, a head end, and an outside surface, the base end of the shaft portion fixedly joined to the base portion; a plurality of support portions joined to the first surface of the base portion and to the shaft portion; and a head portion joined to the head end of the shaft portion. The shaft portion and the head portion together define a channel extending longitudinally through the shaft portion and the head portion, the channel forming a head-end opening at the head portion.

Another embodiment is a method of protecting a wall structure. The method includes the following steps: affixing a first surface of an adhesive plate to a doorstop device; affixing a second surface of the adhesive plate to the wall structure, thereby adhesively affixing the doorstop device to the wall structure; inserting a fastener into a longitudinally-extending channel defined by a shaft portion and a head portion of the doorstop device; inserting a tool into the longitudinally-extending channel, causing the tool to engage a head of the fastener within the longitudinally-extending channel; and rotating the tool and fastener, causing the fastener to penetrate the wall structure, thereby further affixing the doorstop device to the wall structure.

### BRIEF DESCRIPTION OF THE FIGURES

The invention can be understood in consideration of the following detailed description of various embodiments of the invention in connection with the accompanying drawings, in which:

FIG. 1 is a perspective view of a doorstop system, according to an embodiment of the present disclosure;

FIG. 2 is a front view of a doorstop device with an adhesive plate of the doorstop system of FIG. 1, according to an embodiment of the present disclosure;

FIG. 3 is a cross-sectional view of the doorstop device with plate of FIG. 2, according to an embodiment of the present disclosure;

FIG. 4 is a rear view of an embodiment of a doorstop device, according to an embodiment of the present disclosure; and

FIG. 5 is a right side view of another embodiment of a doorstop device, according to an embodiment of the present disclosure.

FIG. 6 is a left side view of a doorstop device, according to an embodiment of the present disclosure;

FIG. 7 is a top view of a doorstop device, according to an embodiment of the present disclosure;

FIG. 8 is a bottom view of an adhesive plate, according to an embodiment of the present disclosure;

FIG. 9 is a perspective view of a doorstop device, according to an embodiment of the present disclosure;

FIG. 10 is a front view of a doorstop device in a flexed configuration, according to an embodiment of the present disclosure; and

FIG. 11 is a rear view of a doorstop device in a flexed configuration, according to an embodiment of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

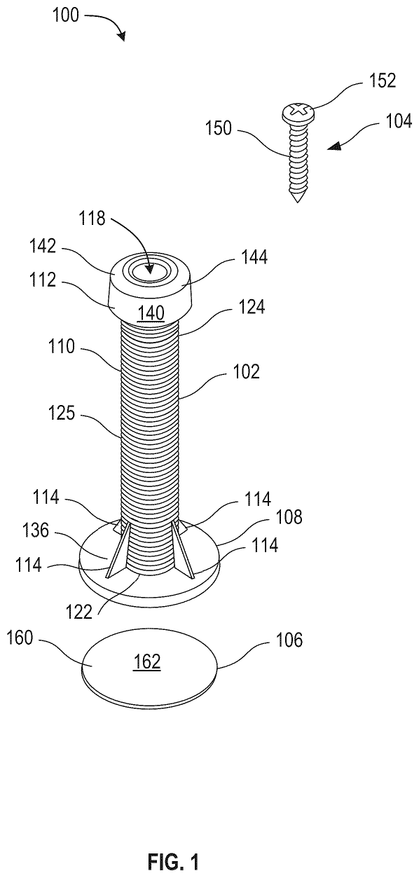

Referring to FIG. 1, an embodiment of doorstop system 100 is depicted. In this embodiment, and as depicted, doorstop system 100 includes doorstop device 102, optional fastener 104 and adhesive plate 106.

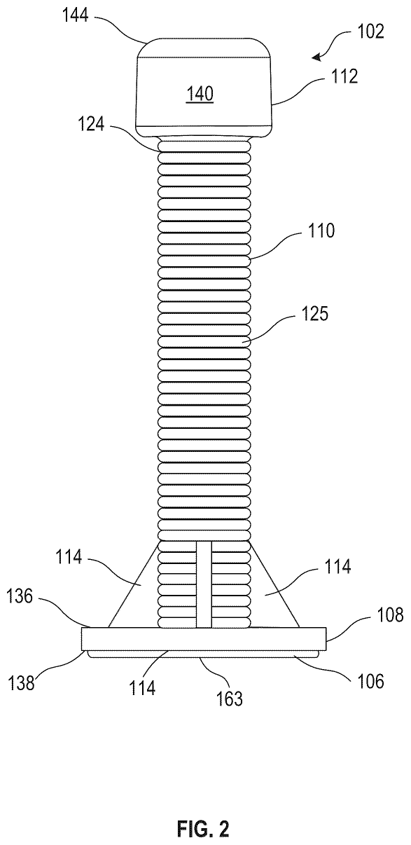

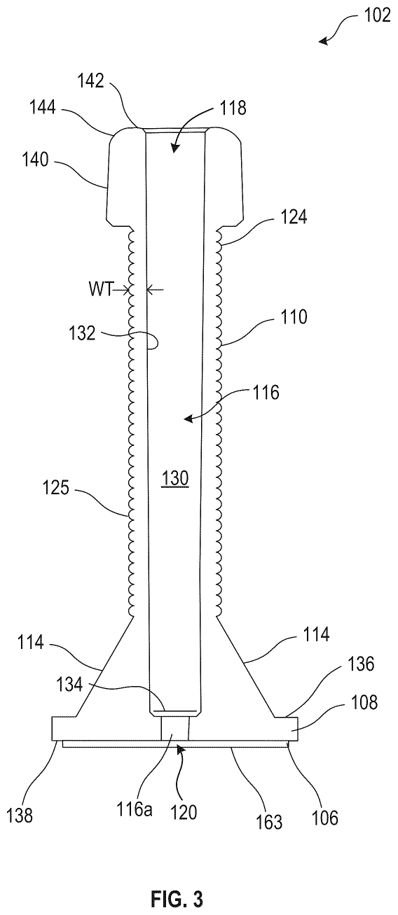

Referring also to FIGS. 2-3, an embodiment of doorstop device 102 with attached adhesive plate 106 is depicted. In this embodiment, doorstop device 102 includes base portion 108, longitudinally-extending shaft portion 110, head portion 112 and a plurality of support portions 114. Shaft portion 110 and head portion 112 together define longitudinally-extending channel 116 with head-end opening 118 and optional base-end opening 120.

In an embodiment, all portions of doorstop device 102, including base portion 108, shaft portion 110, head portion 112 and support portions 114 comprise a common material, such as a polymer material. In one such embodiment, doorstop device 102 may comprise a single, unity or integral structure, rather than an assembly of separate parts. In one such embodiment, doorstop device 102 may be produced via an injection-molding process. When doorstop device 102 is formed as a unitary, integral structure, manufacturing costs are reduced, while maintaining full functionality of the device, as described further below.

In some embodiments, doorstop device 102 may be made of a thermoplastic material. Examples of suitable thermoplastic materials may include thermoplastic polyurethane (TPU), thermoplastic elastomers (TPE), thermoplastic vulcanizates (TPV), thermoplastic polyolefin (TPO), styrenic block copolymers (such as SEBS or SBS), polyester-based elastomers, and polyamide-based elastomers. Desirable material properties for doorstop device 102 may include high elongation at break (e.g., greater than 300%), good tensile strength, elastic memory or the ability to return to an original shape after deformation, Shore hardness in a semi-flexible range (e.g., Shore A hardness from about 70 A to about 98 A), durability and resistance to fatigue, and the ability to absorb impact energy. In one embodiment, doorstop device 102 may comprise a thermoplastic polyurethane (TPU) material. In one such embodiment, the TPU material may have a Shore hardness of approximately 95 A, which places the material in a semi-flexible category, that is, firm enough to hold its shape, yet flexible enough to absorb impact. The specific durometer of approximately 95 A may be selected to achieve the required spring-back memory while maintaining structural integrity. In one example, the TPU material may be Overture™ TPU or similar TPU materials having comparable properties. TPU materials may exhibit high elongation at break, such as the ability to stretch more than three times their original length, and good tensile strength. Other elastomeric materials and hardness ranges are contemplated, including Shore A hardness ranging from about 70 A to about 98 A, depending on the desired flexibility and energy absorption characteristics. The selection of material hardness may affect the degree of flex, rebound behavior, and durability of doorstop device 102.

In some embodiments, the combination of the Shore A hardness of the thermoplastic material, the undulating surface geometry, and the wall thickness of shaft portion 110 (e.g., from approximately 1 mm to approximately 5 mm) may provide spring-like flexibility and elastic rebound characteristics that replicate the behavior of a metal coil spring doorstop without mechanical moving parts. The specific durometer of approximately 95 A may be selected to achieve the required spring-back memory while maintaining structural integrity. The elastomeric material selection may also contribute to noise reduction upon door impact, providing a quieter operation compared to traditional metal coil springs.

Doorstop device 102 may be manufactured via injection molding, additive manufacturing (such as 3D printing), or other suitable molding processes. The unitary construction of doorstop device 102 provides several advantages, including simplified manufacturing, reduced cost, and elimination of failure points associated with multi-part assemblies. Additionally, the one-piece construction may provide safety benefits by eliminating choking hazards from removable caps and pinch points from wire coils, making doorstop device 102 safer for use in homes with children. In an embodiment, doorstop device 102 comprises no metal parts, no moving parts, and requires no assembly, being a single unitary elastomeric body.

In another embodiment, doorstop device 102 may also include adhesive plate 106 pre-assembled or pre-attached to base portion 108 of doorstop device 102 so that doorstop device 102 with adhesive plat 106 forms a unitary, pre-assembled doorstop or doorstop device for the sake of user convenience.

In a different embodiment, rather than a unitary, integral structure, doorstop device 102 may include a head portion 112 that is a separate and distinct component from base portion 108 and shaft portion 110. In one such embodiment, head portion 112 may comprise a material that is different from base portion 108 and shaft portion 110, such as rubber, or a softer polymer.

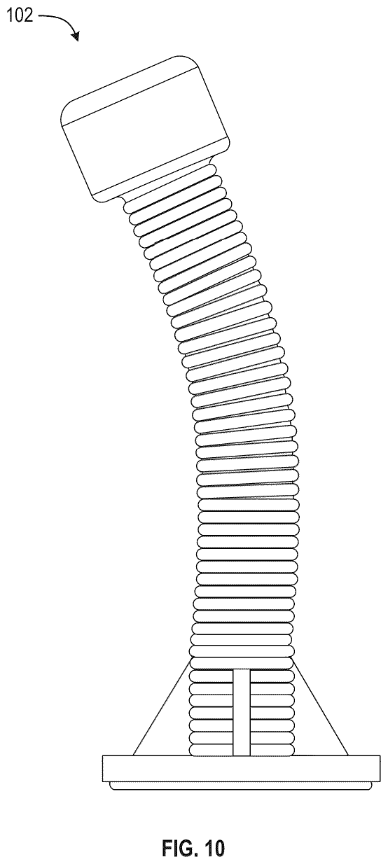

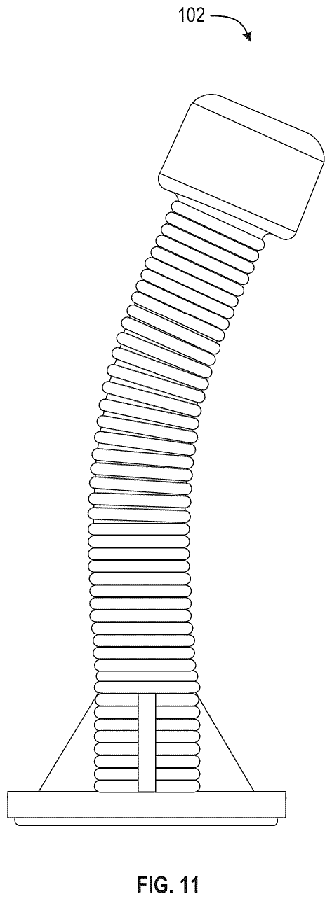

Shaft portion 110 is a deformable body and includes first or base end 122 and second or head end 124 and extends between base portion 108 and head portion 112, with outer surface 125. Shaft portion 110 forms a cantilever with base end 122 being a fixed end and head end 124 being a free end. Shaft portion 110 is configured to flex along its length in a spring-like manner when subjected to lateral forces, such as when contacted by a door. The flexibility of shaft portion 110 allows doorstop device 102 to absorb impact forces and return to its original upright configuration, as illustrated in FIGS. 10-11. The omnidirectional flexibility of shaft portion 110 enables doorstop device 102 to respond to impacts from a door, foot or similar, from multiple directions. In some embodiments, shaft portion 110 may have a generally circular outer cross-section. In other embodiments, shaft portion 110 may have an oval, elliptical, or other cross-sectional shape to provide desired flexibility characteristics or aesthetic appearance. Channel 116 defined at least in part by shaft portion 110 may be generally cylindrical in shape and is defined by an inner surface 130 of shaft portion 110, head portion 112, and in some embodiments, base portion 108. The body includes a continuous hollow core extending longitudinally, enabling axial compression and controlled flex. In an embodiment, channel 116 may extend through base portion 108, defining sub-channel portion 116a having a diameter that is smaller than a diameter of channel 116 formed by shaft portion 110. Inner surface 130 includes longitudinally-extending inner wall surface 132 and latitudinally-extending base-end surface 134. In the embodiment depicted, base-end surface 134 forms an annular ring opening into sub-channel 116a and base-end opening 120. In other embodiments, channel 116 may have different cross-sectional shapes, such as circular, oval, or multi-channel configurations.

Channel 116 may provide controlled flexibility and energy absorption for doorstop device 102. The hollow internal structure enables doorstop device 102 to compress and flex upon door impact, mimicking spring behavior through elastic deformation rather than mechanical components. In some embodiments, head-end opening 118 may be closed or partially restricted for increased pneumatic buffer effect. In such embodiments, the hollow internal channel may function as an air-compression chamber, wherein a closed or restricted head-end opening allows air within channel 116 to compress upon impact, providing pneumatic damping. The size of any opening may be varied to control the rate of air flow and thus the damping characteristics. The interaction between head portion 112 and the hollow core may provide a pneumatic buffer effect, and air compression within channel 116 may provide secondary deceleration of the door. Upon contact with the swinging door, head-end opening 118 may be partially blocked, thereby enhancing the pneumatic buffer effect. Consequently, pneumatic damping may occur even when head-end opening 118 is the same or similar size as the diameter of channel 116. Further, a tapered edge around head-end opening 118 may facilitate sealing contact with a door surface, further enhancing the pneumatic buffer effect. In some embodiments, the channel may be configured to provide pneumatic damping upon compression of the doorstop device by trapping and compressing air within the channel.

In an embodiment, head-end opening 118 may be the same size as an diameter of channel 116 for ease of manufacture, and for facilitating entry of a fastener 104, when present. In other embodiments, head opening 118 may form a smaller diameter as compared to a diameter of channel 116 to maximize the air compression effect as described above.

Upon contact with a swinging door, doorstop device 102 compresses and flexes due to the hollow core and elastomeric material, with impact energy absorbed and dissipated through elastic deformation. Doorstop device 102 may then rebound to its original shape without permanent deformation. This behavior is intended to replicate the feel and function of a traditional spring coil doorstop while remaining quieter and safer. In some embodiments, the hollow TPU core and elastomeric construction may provide quieter operation compared to traditional metal coil springs, reducing noise upon door impact. Shaft portion 110 defines wall thickness WT along its length. Wall thickness WT can be varied in order to vary the stiffness of shaft portion 110, with a thinner wall thickness WT allowing greater flexibility and pivot movement of shaft head end 122 and head portion 112 about second, fixed end 122 of shaft portion 110. In some embodiments, wall thickness WT may be graduated or varied along the length of shaft portion 110 to provide different flex characteristics at different points along the shaft, such as greater flexibility near the head end and greater stiffness near the base end. In some embodiments, wall thickness WT may range from approximately 1 mm to approximately 5 mm (about 0.04 inches to about 0.2 inches), with thinner walls providing greater flexibility and thicker walls providing greater rigidity and durability.

As depicted, outer surface 125 of shaft portion 110 may form a helical or undulating surface having a series of ridges and grooves that provide a grippable surface for a user and improved bendability of shaft 110. Alternatively, shaft portion 110 may form an undulating surface that is also helical. The undulating configuration may create a coil-like or spring-like external appearance that mimics traditional spring doorstops. The ridge and groove pattern may also provide functional benefits beyond aesthetics: the geometry may guide flex along a preferred axis, reduce buckling under load, and improve durability and rebound behavior. In some embodiments, the undulating geometry provides a soft catch upon initial impact and progressive resistance as the material compresses, mimicking the behavior of a mechanical spring without the noise, vibration, or failure points associated with metal coil springs. The coil-like geometry may be continuous or segmented, and may have uniform or variable pitch along the length of shaft portion 110. In some embodiments, the undulating surface may comprise a series of annular ridges that create an appearance similar to stacked toroidal shapes or donut-shaped rings. The spacing between adjacent ridges and grooves may range from approximately 2 mm to approximately 8 mm (about 0.08 inches to about 0.3 inches), and may be uniform or variable along the length of shaft portion 110 to achieve desired flexibility, aesthetic appearance, and structural performance.

In an embodiment, base portion 108 is joined to base end 122 of shaft portion 110 and generally forms a disk or plate shape extending radially from base end 122. In other embodiments, base portion 108 may form other shapes, such as a square or other multi-sided polygon. In some embodiments, base portion 108 may form a disk shape. In other embodiments, base portion 108 may have other shapes, such as square, rectangular, oval, or polygonal, depending on the intended application or aesthetic preference. Base portion 108 includes first or upper surface 136 and second or lower surface 138. Lower surface 138 is configured to receive adhesive plate 106.

Head portion 112 is joined to shaft portion 110 at head end 124 of shaft portion 110. In an embodiment, head portion 112 may form a circular shape about its circumference, and includes outer surface 140, which includes stop surface 142 and tapered edge 144. Stop surface 142 is configured to act as a primary contact surface to contact a door, wall, wall molding, or other structure to be protected, while tapered edge 144 is configured to act as a secondary contact surface. In some embodiments, head portion 112 may have a rounded, flat, domed, or tapered shape. The shape of head portion 112 may be selected to provide desired contact characteristics with a door or other surface.

The plurality of support portions 114 extend from surface 136 of base portion 108 upwardly onto shaft 110, providing support to shaft portion 110 to limit bending of shaft portion 110 near base end 122 of shaft portion 110. The support portions 114 may help distribute forces applied to shaft portion 110 across a larger area of base portion 108, which may reduce stress concentration at the junction and help prevent base portion 108 from being separated or ripped from shaft portion 110 during repeated flexing and impact forces. In an embodiment, the support portions 114 limit bending of shaft portion 110 near base end 122, causing bending to occur above the support portions 114 rather than at the junction between shaft portion 110 and base portion 108. This configuration may help protect the structural integrity of the junction and extend the useful life of doorstop device 102. In an embodiment, and as depicted, doorstop device 102 may include four support portions, though more or fewer are contemplated, depending on a desired degree of bending of shaft portion 110 and the desired level of structural reinforcement. Each support portion 114 may form a triangular shape, but other shapes are contemplated. The number of support portions may range from 2 to 8 or more, with more support portions providing greater rigidity near the base and fewer support portions providing greater flexibility. The height of support portions 114 may also be varied, with taller support portions extending the reinforced zone higher up shaft portion 110 and affecting where bending begins. The thickness of support portions 114 may also be varied, with thicker support portions providing more reinforcement. In some embodiments, support portions 114 may taper as they extend up shaft portion 110, providing graduated reinforcement. In some embodiments, transitions between support portions 114 and shaft portion 110 may be rounded to reduce stress concentration points. Each support portion 114 may form a triangular shape, but other shapes are contemplated. Support portions 114 may be equidistantly spaced apart, in an embodiment. Evenly spaced support portions (e.g., four support portions at 90° intervals) may allow consistent flex in all directions, while unevenly spaced support portions may create preferential bending directions. In some embodiments, support portions 114 may aid in injection molding by providing material flow paths and reducing sink marks during manufacturing. Support portions 114 may also contribute to the overall coil-like or spring-like appearance of doorstop device 102. In some embodiments, doorstop device 102 may not include support portions 114. In such embodiments, bending of shaft portion 110 may occur at or near the junction between shaft portion 110 and base portion 108, which may result in different flex characteristics and may be suitable for applications where greater flexibility near the base is desired. In some embodiments, doorstop device 102 may not include support portions 114. In such embodiments, bending of shaft portion 110 may occur at or near the junction between shaft portion 110 and base portion 108, which may result in different flex characteristics and may be suitable for applications where greater flexibility near the base is desired.

Referring specifically to FIG. 1, optional fastener 104 may comprise a threaded screw having a shaft 150 and head 152. Optional fastener 104 can be sized to fit into channel 116 of doorstop shaft portion 110, with screw shaft 150 configured to fit through base-end opening 120 such that head 152 abuts surface 134 of shaft portion 110 and a portion of shaft 150, including an end, protrudes through base portion 108 and through adhesive plate 106. Doorstop 102 is configured to receive a tool into channel 116 to engage with head 152 so that the user may rotate fastener 104, causing fastener 104 to penetrate and project through adhesive plate 106, thereby affixing doorstop 102 to a wall structure. In some embodiments, fastener 104 may be omitted entirely, with doorstop 102 being secured to a structure solely by means of adhesive plate 106. Channel 116 may serve as a dual-purpose aperture that maintains the monolithic integrity of doorstop device 102 while providing a ready-path for optional mechanical fastening without the use of secondary hardware or assembly.

Referring to FIGS. 1-3, adhesive plate 106, in an embodiment, forms a flat disk-or plate-like body 160 with first or base-contacting surface 162 and oppositely located second or outer surface 163. Adhesive plate 106, in an embodiment, comprises a polymer or plastic material that may be the same or may be different from the material of doorstop device 102. In some embodiments, adhesive plate 106 may be configured for use with Low Surface Energy (LSE) adhesives, which enable bonding to flexible elastomeric substrates such as TPU without the use of primers or adhesion promoters. In one example, the LSE adhesive may be 3M™ VHB™ LSE-110WF or similar LSE adhesives having comparable properties. The use of LSE adhesives with TPU may solve the technical problem of adhesive delamination from flexible elastomeric substrates, providing a durable bond between adhesive plate 106 and base portion 108. The combination of the TPU material of doorstop device 102 and the LSE adhesive of adhesive plate 106 may provide a synergistic relationship, wherein the LSE adhesive is specifically formulated to bond with flexible, low surface energy elastomeric substrates such as TPU, resulting in a durable attachment that resists delamination under repeated flexing and impact forces. In some embodiments, the adhesive plate 106 may include a Low Surface Energy (LSE) adhesive on the base-contacting surface 162, and the polymer material of doorstop device 102 may comprise thermoplastic polyurethane, wherein the LSE adhesive is specifically configured to bond with the thermoplastic polyurethane substrate.

Base-contacting surface 162 and outer surface 163 may be coated with an adhesive material, such as glue, epoxy, or similar, such that adhesive plate 106 may be adhesively attached to base portion 108 and adhesively attached to a door, wall, wall molding or other structure to be protected. In an embodiment, the doorstop may be mounted using pressure-sensitive adhesive. In an embodiment, during manufacture, adhesive plate 106 is affixed to base portion 108 of doorstop device 102 by applying an adhesive material to surface 138 of base portion 108 and/or to surface 162 of adhesive plate 106 and pressing adhesive plate 106 to base portion 108. In an embodiment, adhesive plate 106 is permanently affixed to base portion 108.

Outer surface 163 of adhesive plate 106, in an embodiment, is coated with an adhesive material that is configured to attach doorstop 102 with adhesive plate 106 to a door, wall, wall molding or other structures to be protected. In an embodiment, the adhesive material coating outer surface 163 is different from the adhesive material affixing adhesive plate 106 to base portion 108, and may be configured to allow doorstop 102 with adhesive plate 106 to be removably attached to a structure to be protected (door, wall, molding, etc.). The adhesive mounting enables installation without tools, screws, or wall penetration, making doorstop system 100 suitable for rental properties and other environments where wall damage is undesirable. Adhesive plate 106 may also include a removable cover, protective liner, or film over the adhesive material on outer surface 163, applied at the time of manufacture to protect and shield the coating, and configured to be removed by a user prior to affixing doorstop 102 with adhesive plate 106 to a structure to be protected. Doorstop system 100 may be mounted in different orientations, including to a baseboard, wall, floor, or door.

In a primary embodiment of doorstop system 100, doorstop 102 may be affixed to a structure such as a wall or wall molding or similar solely by means of attached adhesive plate 106, without the use of any mechanical fasteners. In other embodiments, doorstop system 100 may additionally include optional fastener 104 to provide supplemental mechanical attachment in addition to adhesive plate 106. In yet other embodiments, doorstop system 100 may include only fastener 104 without adhesive plate 106. In an embodiment that does not include fastener 104, channel 116 may be closed at base end 122 of shaft portion 110 and not define opening 120 or sub-channel 116a. In some embodiments, base-end opening 120 and sub-channel 116a may or may not be present depending on whether the optional fastener 104 is intended to be used.

In some embodiments, doorstop devices 102 may be manufactured in various colors depending on the intended application or aesthetic preference. In some embodiments, doorstop device 102 may be manufactured in different overall lengths or diameters depending on the intended application or mounting location. In some embodiments, doorstop device 102 may have an overall length or height of approximately 3 to 6 inches (about 75 mm to about 150 mm). The base portion 108 may have a diameter of approximately 1 to 2 inches (about 25 mm to about 50 mm). The shaft portion 110 may have a diameter of approximately 0.5 to 1.5 inches (about 12 mm to about 38 mm).

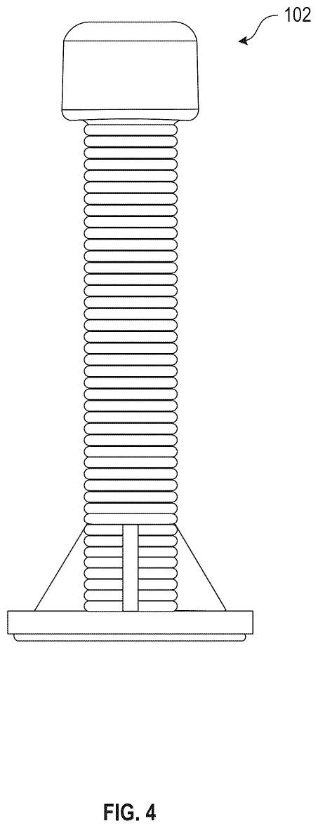

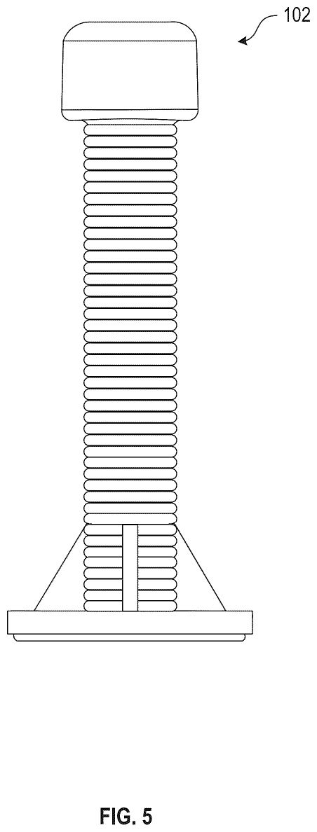

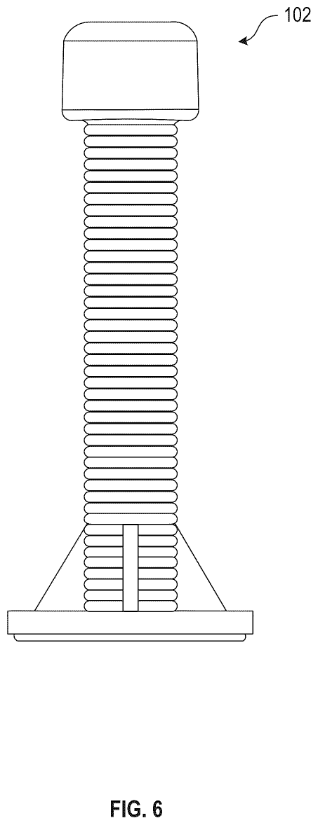

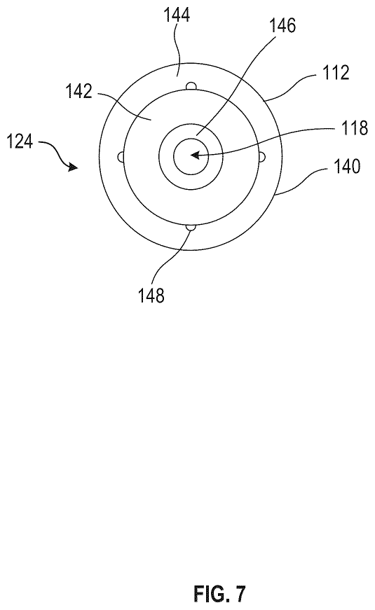

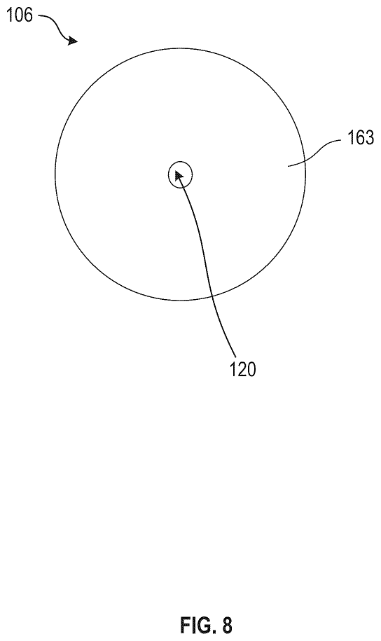

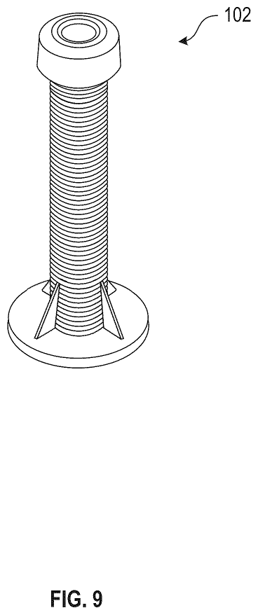

FIGS. 4-6 depict rear, right side, and left side views of doorstop device 102, which are substantially similar to the front view of FIG. 2 due to the radial symmetry of doorstop device 102. FIG. 7 depicts a top view of doorstop device 102 showing head portion 112 and head-end opening 118. FIG. 8 depicts a bottom view of adhesive plate 106 showing outer surface 163 and base-end opening 120. FIG. 9 depicts a perspective view of doorstop device 102. FIGS. 10-11 depict doorstop device 102 in flexed configurations, with the shaft portion bent to the left (FIG. 10) and to the right (FIG. 11), demonstrating the flexibility of shaft portion 110 along its length. In some embodiments, doorstop device 102 may be configured to deflect at angles of approximately 15 to 45 degrees from vertical when subjected to typical door impact forces, and to return to its original upright position within approximately 1 to 3 seconds after the force is removed.

The embodiments above are intended to be illustrative and not limiting. Additional embodiments are within the claims. In addition, although aspects of the present invention have been described with reference to particular embodiments, those skilled in the art will recognize that changes can be made in form and detail without departing from the spirit and scope of the invention, as defined by the claims.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed:

1. A doorstop system, comprising:
a doorstop device that includes:
a base portion including a first surface and a second surface;
a longitudinally-extending shaft portion including a base end, a head end, and an outside surface, the base end of the shaft portion fixedly joined to the base portion, wherein the outside surface forms an undulating surface;
a head portion joined to the head end of the shaft portion;
wherein the base portion, shaft portion, plurality of support portions and head portion form a unitary, integral structure;
wherein the shaft portion and the head portion together define a channel extending longitudinally through the shaft portion and the head portion, the channel forming a head-end opening at the head portion;
an adhesive plate having a base-contacting surface adhesively affixed to the second surface of the base portion.

2. The doorstop system of claim 1, wherein the doorstop device comprises a polymer material.

3. The doorstop system of claim 2, wherein the unitary, integral structure comprises a homogenous polymer material.

4. The doorstop system of claim 1, wherein the channel extends through the base portion and defines a base-end opening.

5. The doorstop system of claim 1, wherein the undulating surface comprises a series of ridges and grooves.

6. The doorstop system of claim 1, further comprising a fastener configured to fit within the channel.

7. The doorstop system of claim 1, further comprising a plurality of support portions joined to the first surface of the base portion and to the shaft portion, wherein each of the plurality of support portions forms a triangular shape.

8. The doorstop system of claim 2, wherein the polymer material comprises a thermoplastic material selected from the group consisting of thermoplastic polyurethane (TPU), thermoplastic elastomers (TPE), thermoplastic vulcanizates (TPV), thermoplastic polyolefin (TPO), and styrenic block copolymers.

9. The doorstop system of claim 8, wherein the thermoplastic material has a Shore A hardness from about 70 A to about 98 A.

10. The doorstop system of claim 1, wherein the doorstop device is manufactured by a process selected from the group consisting of injection molding and additive manufacturing.

11. The doorstop system of claim 1, wherein the base portion forms a disk shape.

12. The doorstop system of claim 1, wherein the doorstop device provides reduced noise upon door impact compared to a metal coil spring doorstop.

13. A doorstop device, comprising:
a base portion including a first surface and a second surface;
a longitudinally-extending shaft portion including a base end, a head end, and an outside surface, the base end of the shaft portion fixedly joined to the base portion; wherein the outside surface forms an undulating surface creating a coil-like external appearance;
a head portion joined to the head end of the shaft portion;
wherein the base portion, shaft portion, plurality of support portions and head portion form a unitary, integral structure comprising a polymer material; and
wherein the shaft portion and the head portion together define a channel extending longitudinally through the shaft portion and the head portion, the channel forming a head-end opening at the head portion.

14. The doorstop device of claim 13, wherein the polymer material comprises a thermoplastic material.

15. The doorstop device of claim 13, wherein the undulating surface comprises a series of ridges and grooves configured to guide flex along a preferred axis and reduce buckling under load.

16. The doorstop device of claim 13, wherein the shaft portion defines a wall thickness that is graduated along a length of the shaft portion.

17. A method of protecting a structure, comprising:
providing a doorstop device having a base portion, a longitudinally-extending shaft portion, a head portion, and a channel extending longitudinally through the shaft portion and the head portion;
affixing a first surface of an adhesive plate to the base portion of the doorstop device; and
affixing a second surface of the adhesive plate to the structure, thereby adhesively affixing the doorstop device to the structure.

18. The method of claim 17, wherein the structure is a door.

19. The method of claim 17, wherein the structure is a wall.

20. The method of claim 17, wherein the structure is a molding on a wall.
